(19) United States
(12) Patent Application Publication
(10) Pub. No.: US 2007/0052548 A1
(43) Pub. Date: Mar. 8, 2007

(54) Remote control system and authentication method

(76) Inventors: Neil A Hankin, HORLEY (GB); Barrie N. Barnes, Stoneleigh (GB); Roderick J. Miller, St. Leonards On Sea (GB); Robin J. Blackwell, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/539,370

(22) PCT Filed: Dec. 9, 2003
(86) PCT No.: PCT/IB03/05889

§ 371 Date: Jun. 15, 2005

(30) Foreign Application Priority Data
Dec. 19, 2002 (GB) 0229700.0

(51) Int. Cl. G08C 17/02; G08C 19/00

(52) U.S. Cl. 340/825.69; 340/5.54; 340/5.61; 340/5.8; 348/734

(57) ABSTRACT

A radio frequency controlled system (10,20,30) is described in which a user's remote control (30) having a unique identifier is only accepted by a device (10, 40a) to enable remote control if authenticated. The authentication process causes the device (10, 40a) to generate and issue a key sequence which the user must input. Commands from a remote control unit (30) having the identifier are only accepted if the key sequence has been previously, and correctly input. The key sequence is issued so that only a user in close proximity of the device with direct line of sight/hearing can input it on the device. Hence, inadvertent control by a neighbours' radio frequency remote control unit is eliminated. The invention is described employing the ZigBee radio standard.

The present Invention relates to a radio frequency remote control system for controlling devices, and further relates to devices suitable for use in the system, and also relates to methods of authenticating remote control. The present invention has particular, but not exclusive, application to radio remote control of consumer electronic devices such as televisions, audio or Hi-Fi systems, digital video players and recorders, and set top boxes.

The remote control of consumer devices In the home such as televisions, digital video players and recorders, set top boxes and audio Hi-Fi equipment is often achieved with a dedicated remote control unit (RCU). The RCU typically enables a user to control a variety of system functions from a distance. For example, in the case of a device such as a TV or a VCR the user may increase the volume or change the received channels. Many hand-held remote control units employ infrared (IR) mechanisms to transmit the control signals to an infrared receiver embedded in the device. The use of infrared based remote control is relatively low in cost, operates over a relatively short distance and requires line of sight communication. It is common for a user to have independent remote control units for each electronic device in his possession, or to have a single “universal remote control” which can learn the command signals from other remote control units and then be used for each device, with the user required to select the device for control prior to issuing control commands.

Other remote control systems employ radio frequency (RF) based remote control mechanisms. The use of RF may increase the range of communication and does not require direct line of sight with the receiving device, providing a more flexible control experience for the user. However, the ability of RF signals to penetrate walls and ceilings can lead to the inadvertent control of a neighbour's device(s), much to the neighbour's annoyance.

Typically, such a system attempts to prevent this interference by allocating a control identifier to a system, with the RCU transmitting such an identifier with each command transmission. The identifier may be set u sing switches or dials provided on the device and RCU.

The patent U.S. Pat. No. 5,500,691 describes the initial set-up of an RF remote control for a video system in which the RF remote control unit is also provided with an infrared transmitter. The video system enables a user to enter a remote control identifier for the RF transmitter through a remote identifier set-up display using the infrared transmitter. RF command signals are ignored by the system until the remote control identifier is entered.

Whilst the aforementioned in some part enable the uptake of radio frequency in-home control of a consumer's devices, the limited range of identifiers presents problems in that the number of devices that may be controlled by a single remote control unit is limited. Furthermore, the limited number of identifiers increases the probability of inadvertent or even malicious control. Finally, manually setting dip-switches or identifiers for every device is inconvenient and cumbersome to the consumer and in particular is incompatible with emerging radio standards which may be employed in home networking.

It is therefore an object of the present invention to provide a method for authenticating radio frequency remote control which is compatible with emerging radio protocols. It is also an object of the present invention to provide a system and devices suitable for practising the method.

According to a first aspect of the present invention there is provided a method for authenticating an exchange of radio identifiers in a system having a device and a remote control unit, both of which operate in compliance with a predetermined radio protocol, comprising exchanging respective radio identifiers, generating a key sequence to be input for authentication, issuing a request to a user for said key sequence to be input, authenticating the input key sequence with that generated, and storing the remote control unit identifier to enable control in dependence on said authentication.

According to a second aspect of the present invention there is provided a system comprising a radio remote control unit for controlling a device having communication means for communicating with said remote control unit according to a predetermined radio protocol and in which radio identifiers are defined, the system further comprising means for generating a key sequence for authentication, means for issuing a request to a user for said key sequence to be input, means for receiving and authenticating the input key sequence with that generated, and means for storing the radio identifier of the remote control unit to enable control at least in part in dependence on said authentication.

The system and method aspects of the present invention enable a user to authenticate an exchange of radio identifiers between a device and his remote control unit, preferably In a system utilising a radio protocol in which radio modules are fitted to, or embedded in the users devices.

In an embodiment the device is represented by an audio system (commonly called a Hi-Fi) fitted with an embedded ZigBee radio module, as is a remote control unit in the form of, for example the Philips Pronto™. The ZigBee radio standard (www.zigbee.com) is a low power, low latency standard particularly suitable for home networking and control. It requires that devices are equipped with 64-bit unique identifiers (as does the Bluetooth standard www.bluetooth.com) which are used in radio exchanges. In a first exchange the identifier of the RCU is temporarily stored by the device which, according to the methods of the present invention, begins an authentication process.

In the process the device generates a key sequence to be input and issues a request to a user for said key sequence to be input. The request in this embodiment is in the form of synthesised speech output on the speaker system of the Hi-Fi. The key sequence is randomly generated in accordance with the user input capabilities of the Hi-Fi. For example, the key sequence issued may comprise the following audible instructions,

“Please press the following buttons in the following order:
CD play,
CD stop,
CD skip forward”
   The Hi-Fi monitors its user interface buttons for the sequence. After a particular time period, the Hi-Fi compares any input sequence with the issued sequence. If the sequences match then the radio identifier of the remote control unit is authenticated and stored in a table in the Hi-Fi. The Hi-Fi subsequently accepts radio frequency commands from the RCU having that identifier which is indicated in the table as having been previously authenticated.

In another embodiment, a device such as a television (TV) may display the key sequence for Input on its display screen.

In yet a further embodiment, the input key sequence is entered on the keypad of the RCU of the user, the RCU subsequently transmits the key sequence to the device for authentication, and wherein the device then requests another input on the device itself to confirm authentication.

Hence, consumer electronic devices having varying output capability are able to initially ascertain that a received device identifier came from an RCU of a user who is within close proximity of, and has physical access to, the devices. Therefore, radio commands from a neighbours RCU having a different identifier are not accepted by the device, even if the neighbour has surreptitiously obtained the network addresses of such devices on his neighbours network and is deliberately targeting commands at those device addresses surreptitiously.

Advantageously, the method and system enable the use of radio systems having large identifiers without encumbering the user with having to input the large identifiers. For example, a 64-bit identifier is represented in decimal form by a string comprising up to 20 digits, which an average consumer cannot be expected to input. Furthermore, many devices may be catered for in a home network with little chance of inadvertent control since the identifiers in such systems are unique.

The present invention will now be described, by way of example only, and with reference to the accompanying drawings wherein:

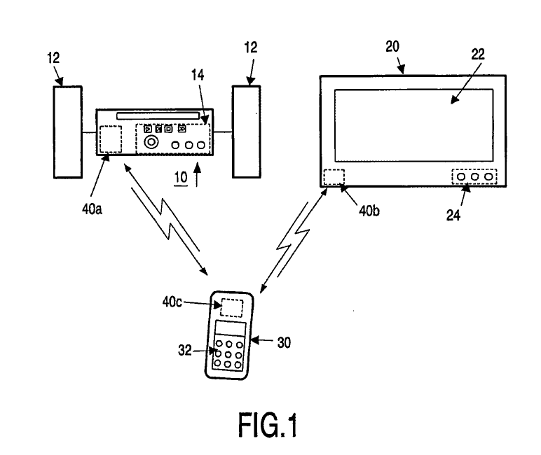

FIG. 1 is an example system capable of RF remote control,

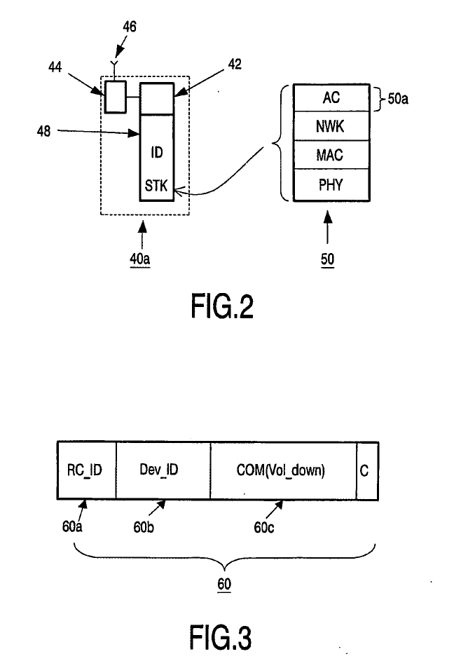

FIG. 2 is a block diagram of radio components of the system,

FIG. 3 is a diagram of a radio datagram for use with the system,

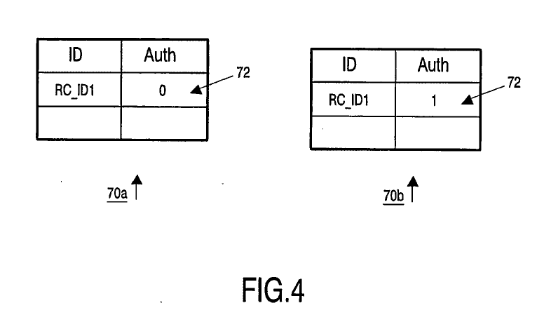

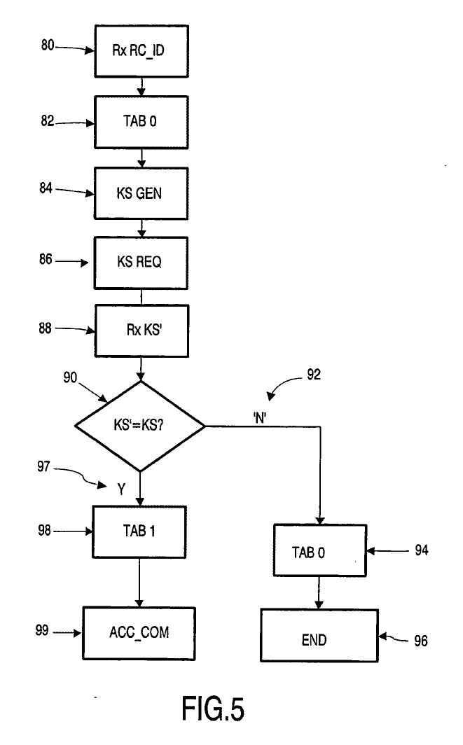

FIG. 4 is a diagram of an example data structure in the form of a table before authentication and after authentication has been performed,

FIG. 5 is a flow diagram illustrating a method of authenticating control according to the present invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

FIG. 1 shows a system having a device in the form of a consumer Hi-Fi. The Hi-Fi 10 is connected to audio loud speakers 12 and has input means 14 comprising buttons for operating the functions of the Hi-Fi such as CD-play, CD skip, volume knobs and so on. Also illustrated in FIG. 1 is a television device 20 having a display 22 and input means 24 comprising buttons for operating the television.

A remote control unit, 30 is shown which in conventional fashion has input means 32 in the form of a keypad.

The Hi-Fi 10, television 20 and remote control unit are supplied with radio frequency (RF) radio modules 40a, 40b, 40c respectively to enable RF remote control. In this embodiment the radio modules operate in compliance with the ZigBee radio standard (www.Zigbee.com).

FIG. 2 illustrates typical features of a ZigBee radio module 40a. The module comprises a microcontroller 42 (such as the well known mc8051 chip) coupled to a transceiver 44 and radio antenna 46. The microcontroller 42 has a flash memory area 48 which stores a ZigBee radio stack 50. The stack 50 is conceptually illustrated in FIG. 2 in reference layer form well known to those skilled in the art of digital radio systems. The stack has a physical layer (PHY) a medium control access layer (MAC), a network layer (NWK) and a higher application code (AC) layer 50a. The application code of the AC layer 50a defines the function of the module, and formats data for transmission which is input down through the layers and eventually transmitted over the air interface. Similarly, received radio data is passed up conceptually through the PHY, MAC and NWK layers, reaching the application code which acts on the data. The code loaded in this RCU module 40c embodiment is designed for simple RF remote control transmission whereas that loaded in the device modules 40a and 40b also operates key sequence generation and authentication processes which will be described shortly.

The IEEE and the ZigBee Alliance, in designing the ZigBee protocols and standard, have decided that each ZigBee radio device or module 40a, b, c will have a unique 64-bit radio Identifier. This is shown in FIG. 2 stored in a permanent (e.g. boot block) area of memory 48 as ‘ID’. Two raised to the power of 64 (2⁶⁴) gives a 20 digit decimal number space, representing a possible 18,446,744,073,709,551,616 unique devices.

FIG. 3 illustrates conceptually a ZigBee radio message or datagram 60 having various header fields 60a, 60b, a checksum field (C) and a data or payload field 60c. Radio messages 60 typically have source 60a and destination 60b addresses which in this example contain the identifier RC_ID of the module 40c in the RCU 30 generating the message 60, and the device identifier (Dev_ID) of the target module (e.g. the Hi-Fi 10 having module 40a). The payload field 60c contains control command data illustrated in this example as a command entered by the user of the RCU expressing his wish to turn the volume down COM(Vol_down).

The device modules 40a and 40b also store in memory 48 a list or table of remote control devices (identified by their individual identifiers) which have or have not been authenticated as shown in FIG. 4. For example, table 70a shows that RC_ID1 has not been authenticated, represented by the entry of a zero In cell 72 of the table 70a. Tables 70b illustrates the same table after the RCU identifier (RC_ID1) has been authenticated, with an entry of a one in cell 72.

An example authentication method embodying aspects of the present invention will now be described with reference to FIG. 5. Suppose the owner of RCU 30 has just bought a new ZigBee enabled Hi-Fi 10 as illustrated in FIG. 1. The owner powers the Hi-Fi up and presses a button 14 which puts the Hi-Fi into authentication mode. This involves the Hi-Fi radio module 40a broadcasting its device identifier which the remote control unit 30 receives and acknowledges. The owner of the RCU 30 then attempts to control the Hi-Fi by for example pressing a button 32 representing a volume down command.

The RCU ZigBee module 40c formats a radio message 60 (as shown in FIG. 3) and transmits the message. The Hi-Fi module 40a then begins to step through the authentication process as shown in FIG. 5. In step 80 the device 10 receives for the first time the RCU identifier (Rx RC_ID). The identifier is entered in the table 70a with a null authentication indication in step 82 (TAB 0).

Following this, a key sequence is generated (KS GEN) In step 84. The key sequence relates to the user interface and input means 14 of the device 10. For example, the Hi-Fi 10 may have no or little display area, but will have many buttons such as CD play, CD stop, CD skip forward, CD record and so on. The ZigBee module 40a is provided with an application code profile of the device which defines the buttons available and their functions or labels. The microcontroller, using this information, generates a random key sequence such as, for example “CD play”, “CD stop”, “CD skip forward”. The Hi-Fi then issues a request to the user to input the key sequence in step 86 (KS REQ). This may be done in many ways, using the features and functions of the device. For example, the Hi-Fi may issue synthesised speech which is output from speakers 12 and represents the generated key sequence as an audio message. If the Hi-fi 10 also has a display (not shown), or is itself connected to a home entertainment system having a display then the display means (such as that provided by TV 20) may be employed to issue the key sequence request to the user by displaying the key sequence.

Having issued the key sequence request, the ZigBee module 40a awaits input of the key sequence. For example, the Hi-fi issues the audio request

“please enter the following key sequence, CD play, CD stop, CD skip forward.”

The user is then required to physically interact with the device to be controlled and press the keys to input the key sequence. The user walks up to his Hi-Fi and enters the key sequence KS′, which is communicated to the ZigBee module 40a microcontroller by suitably designed circuitry (e.g. a data bus linking processors in the Hi-Fi, which monitor the user interface 14, to the module 40a). The microcontroller receives the input key sequence KS′ in step 88 (Rx KS′) and then in step 90 compares the sequence received with that Issued (KS′=KS). Should the sequences match then program flow continues via route 97 (Y) to step 98 (TAB 1) where the indication of authorisation 72 in the table is altered to a 1 as shown in table 70b.

However, should the input key sequence not be received in time (e.g. the module waits at step 88 for a set time period of say one minute), or is received but in comparison step 90 a match is not found, the program flow continues via route 92 (N) to step 94 where the table entry is reaffirmed as a zero (TAB 0) and the authorisation program ends at step 96.

In subsequent use the module 40a checks its stored table entries 70b upon receipt of a message 60. The module checks the received source identifier 60b in message 60 with the table 70b (RC_ID) and if the identifier exists in the table and has an authorisation bit set to 1, the payload containing commands is accepted and acted upon, as signified in step 99 (ACC_COM).

However, if the authorisation indicator is 0 (table 70a), or the RC_ID received is not stored in the table, then the message is ignored.

Hence, messages received from a RCU or other devices which have identifiers are only acted upon if the identifier has been previously authenticated. Neighbours RF command messages which penetrate the walls of the user's home are ignored, as are commands from malicious hackers or snoopers who may obtain home device address (identifier) information but cannot issue RF commands since physical key sequence input Is required during an initial authentication process to change the authorisation table entry from a zero to a one.

In another embodiment, the key sequence may be input on the users RCU 30, and transmitted to the device 10, 20. The device 10, 20 however, also requests an input on the device itself from buttons 14, 24 to confirm authentication and before updating the entry in the authorisation table to a 1. Hence even a malicious snooper who ‘listens’ in on the RF messages and obtains the key sequence must still gain physical access to the device to complete authentication.

In another embodiment, the key sequence request and the user input may be split into individual key requests and input in turn. That is, the device requests for example ‘CD play’, the user presses ‘CD play’, the device requests ‘CD stop’, the user presses ‘CD stop’ and so on. Hence, devices with little or no user interface may be fitted with an authorisation switch with for example two positions and a sequence randomly generated (e.g. “switch up, switch up, switch down”, therein enabling authorisation to be obtained for control of that device.

In yet a further embodiment, the key sequence may be requested to be Input on the RCU as well as on the device to confirm authentication.

In the foregoing description, a system, device and methods of authentication were described using the ZigBee radio protocol. Those skilled In the art will appreciate that any radio protocol which defines unique identifiers for its radio devices may be employed in accordance with the teachings of the present invention. Furthermore, any consumer electronic device having radio communication means and a user interface may be equipped for use with the present invention.

From reading the present disclosure, other modifications will be apparent to persons skilled in the art. Such modifications may involve other features which are already known in the design, manufacture and use of RF remote control systems and component parts thereof and which may be used instead of or in addition to features already described herein without departing from the spirit and scope of the present invention.

1. A method for authenticating an exchange of radio identifiers in a system having a device and a remote control unit, both of which operate in compliance with a predetermined radio protocol, comprising:
exchanging respective radio identifiers,
generating a key sequence to be input for authentication,
issuing a request to a user for said key sequence to be input,
authenticating the input key sequence with that generated, and
storing the remote control unit identifier to enable control in dependence on said authentication.

2. A method according to claim 1, wherein the key sequence for authentication is randomly generated.

3. A method according to claim 2, wherein the key sequence is randomly generated in accordance with input means of the device.

4. A method according to claim 3, wherein the key sequence request is output on a display.

5. A method according to claim 3, wherein the key sequence request is output on an audio speaker.

6. A method according to claim 5, wherein the input key sequence is obtained via input means of the device.

7. A method according to claim 5, wherein the input key sequence is obtained via input means of the remote control unit.

8. A method according to claim 1, wherein the user input key sequence must be input within a predefined time period.

9. A system comprising a radio remote control unit for controlling a device having communication means for communicating with said remote control unit according to a predetermined radio protocol and in which radio identifiers are defined, the system further comprising means for generating a key sequence for authentication, means for issuing a request to a user for said key sequence to be input, means for receiving and authenticating the input key sequence with that generated, and means for storing the radio identifier of the remote control unit to enable control at least in part in dependence on said authentication.

10. A device for use with the system of claim 9, further comprising audiovisual means by which the key sequence request is issued to a user.

11. A device as claimed in claim 10, wherein the input key sequence is input by input means of said device.

12. A device as claimed in claim 10, wherein the means for receiving the input key sequence comprise a radio receiver of said communication means.

13. A device as claimed in claim 10, wherein the communication means for communicating with said remote control unit according to a predetermined radio protocol comprise a radio module operating according to the ZigBee radio protocol.
